(19) United States
(12) Patent Application Publication
(10) Pub. No.: US 2005/0198319 A1
(43) Pub. Date: Sep. 8, 2005

(54) Techniques for parental control of internet access including a guest mode

(75) Inventors: Alwin Chan, San Carlos, CA (US); Edward Stanley Ott IV, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yahoo! Inc., Sunnyvale, CA (US)

(21) Appl. No.: 10/870,310

(22) Filed: Jun. 16, 2004

Related U.S. Application Data
(60) Provisional application No. 60/536,870, filed on Jan. 15, 2004.

(51) Int. Cl. G06F 15/16

(52) U.S. Cl. 709/228

(57) ABSTRACT

Techniques are provided for limiting access to Internet content using a parental control filtering system. One or more user systems are connected to the Internet through a network device such as a gateway router. The network device restricts Internet access to pre-selected Internet content in a guest mode without requiring a user to login to a user account. A guest user who does not have a user account is allowed limited access to the Internet through a user system in the guest mode. A user who has a user account can bypass the guest mode and obtain less restrictive access to the Internet by logging into the user account. Parental control settings of any level can be applied to a user account. The parent control setting assigned to a user account are applied to the user system when the user successfully logins to his user account.

### BACKGROUND OF THE INVENTION

The present invention relates to techniques for parental controls of Internet access, and more particularly, to techniques for parental controls of Internet access that include a guest mode.

The diversity of content available to people through the Internet has grown immensely over past several years since the advent of the World Wide Web. As children have become more savvy in their ability to access and utilize Internet content, a strong need has developed to limit children's ability to access certain types of Internet content that parents consider to be objectionable or potentially harmful.

Parental control software systems have been developed that prevent an Internet user from accessing certain Internet sites or Internet protocol (IP) domains. The parental control systems can be programmed to apply different filter settings to different user accounts. A user must login to a user account to access the Internet. The parental control settings applied to a particular user account restrict the Internet content that the user can access.

One problem with many of these parental control systems is that they do not allow a guest user who does not have a user account to access any content on the Internet. Also, many prior art parental control systems do not allow a user using a device with an unknown MAC address to access the Internet. Therefore, it would be desirable to apply parental control filtering of Internet content to unknown devices and guest users.

### BRIEF SUMMARY OF THE INVENTION

The present invention limits access to Internet content using a parental control filtering system. One or more user systems are connected to the Internet through a network device such as a gateway router. The network device restricts Internet access to pre-selected Internet content in a guest mode. For example, the pre-selected content can be one or more IP domains or a locally hosted login page. The present invention allows a guest user who does not have a user account to access the Internet through a user system in a guest mode.

A user who has a recognized user account can bypass the guest mode and obtain less restrictive access to the Internet by logging into the user account. Parental control settings of any desired level can be applied to a user account. The parent control setting assigned to a user account are applied to the user system when the user successfully logins to his user account.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 is a diagram of a hardware and communications system that can implement embodiments of the present invention.

FIG. 2 is a flow chart that illustrates an embodiment of the parental control Internet access features of the present invention.

### DETAILED DESCRIPTION OF THE INVENTION

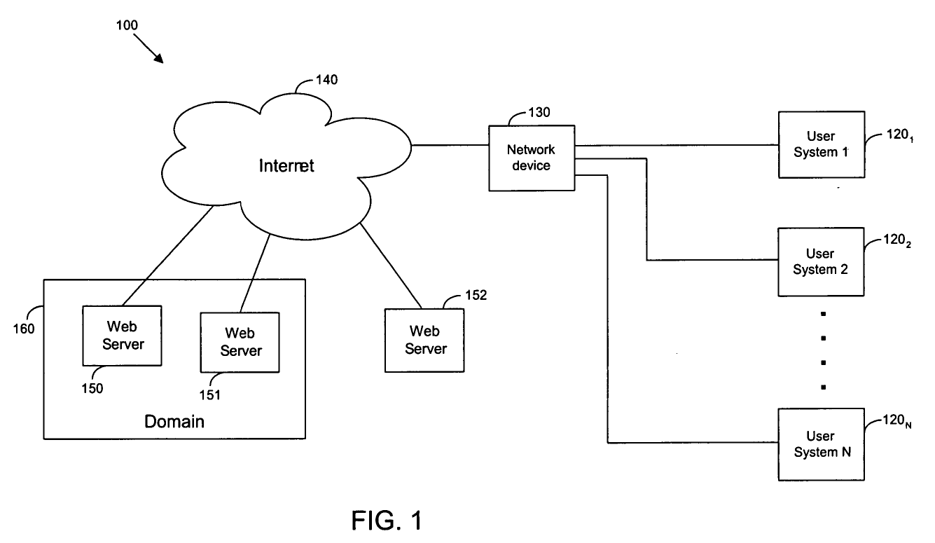

FIG. 1 illustrates a general overview of an information retrieval and communication network 100 including user systems 120₁-120_{N} according to an embodiment of the present invention. In computer network 100, user systems 120₁-120_{N} can communicate through the Internet 140, or other communication network, e.g., over any LAN or WAN connection, with servers such as web servers 150-152.

User systems 120₁-120_{N} are in communication with network device 130. Network device 130 can be, for example, a gateway router that directs Internet traffic to and from a local network that includes user systems 120. User systems 120₁-120_{N} can include desktop personal computers, workstations, laptops, PDAs, cell phones, or any WAP-enabled device or any other computing device capable of interfacing directly or indirectly to the Internet. Mobile devices such as PDAs and cell phones can communicate with network device 130 over a wireless connection. Desktop and laptop computers can be connected to network device 130 through a local area network.

User systems 120 are configured according to the present invention to communicate with any of web server systems 150-152, e.g., to access, receive, retrieve and display media content and other information such as web pages and web sites. As used herein, the term “server system” will typically include one or more logically and/or physically connected servers distributed locally or across one or more geographic locations. The term “server” typically includes a computer system and an associated storage system and database application as is well known in the art. The terms “server” and “server system” will be used interchangeably herein.

User systems 120 typically run an HTTP client, e.g., a browsing program, such as Microsoft's Internet Explorer™ browser, Netscape Navigator™ browser, Mozilla™ browser, Opera™ browser, or a WAP-enabled browser in the case of a cell phone, PDA or other wireless device, or the like. The HTTP client allows users of systems 120 to access, process and view information and pages available to it from web servers over Internet 140.

The present invention is suitable for use with the Internet, which refers to a specific global internetwork of networks. However, it should be understood that other networks can be used instead of or in addition to the Internet, such as an intranet, an extranet a virtual private network (VPN), a non-TCP/IP based network, any LAN or WAN or the like.

According to an embodiment of the present invention, computer code for operating and configuring network device 130 to implement parental controls is downloaded and stored on a memory media such as hard disks, Flash, or RAM/ROM. The entire program code, or portions thereof, can also be stored in any other volatile or non-volatile memory medium or device as is well known, or provided on any media capable of storing program code, such as a compact disk (CD) medium, a digital versatile disk (DVD) medium, a floppy disk, and the like. Network device 130 can, for example, contain a software application that enforces a parental control setting.

Additionally, the entire program code, or portions thereof, may be transmitted and downloaded from a software source, e.g., from one of server systems 150-152, to network device 130 over the Internet as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. Computer code for implementing aspects of the present invention can be implemented in any programming language that can be executed on network device 130 such as, for example, in C, C+, HTML, XML, Java, JavaScript, any scripting language, such as VBScript. In some embodiments, no code is downloaded to network device 130, and needed code is executed by a server, or code already present at user network device 130 is executed.

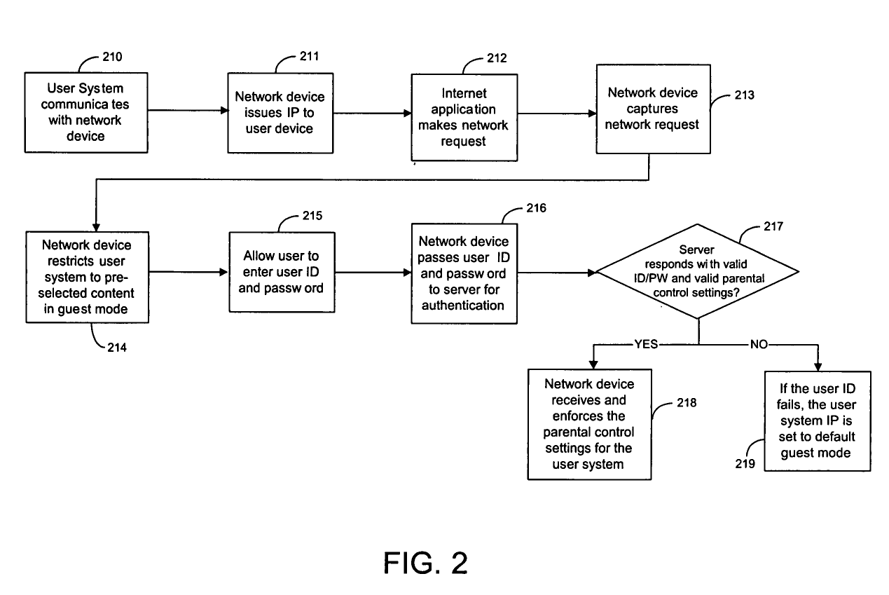

FIG. 2 is a flow chart that illustrates an embodiment of the parental control Internet access features of the present invention. The present invention applies parental controls to user systems 120 to restrict access to Internet content based on various predefined settings. Each user system 120 operates in a guest mode by default. In guest mode, network device 130 restricts access to the Internet to pre-selected content. A user must successfully login to a user account to obtain Internet access beyond the pre-selected content.

At step 210, a user system 120 communicates with network device 130. For example, user system 120 sends its machine access code (MAC) address to network device 130 at step 210. The communication can begin when the user system boots up.

User system 120 can be a computer with a MAC address that is known or unknown to network device 130. For example, user system 120 can be a known desktop computer that has been connected to the local network and communicated with device 130 numerous times. As another example, user system 120 can be a new unknown mobile device that has not communicated with network device 130 before.

Mobile devices such as PDAs can communicate with network device 130 through a wireless connection. Desktop and laptop computers can communicate with device 130 through a wireless or wired local or wide area network.

At step 211, network device 130 issues a unique internet protocol (IP) address to user system 120 in response to receiving its MAC address and an IP request. Network device 130 distinguishes user systems 120 based on their MAC addresses and issues unique IP addresses to each user system 120. At step 212, a web browser or other Internet browsing application on the user system makes a network request to access the Internet. For example, the user may type in a universal resource locator (URL), and, in response, the web browser makes an HTTP request to access a web page.

Network device 130 captures the network request at step 213. At step 214, network device 130 restricts the requesting user system 120 to pre-selected Internet content in a guest mode. For example, network device 130 can restrict user system 120 to only being able to access a locally hosted login page that is stored on device 130 and periodically updated with content downloaded from a web server.

As another example, network device 130 can restrict user system 120 to content residing within one or more pre-selected IP domain names, such as Yahoo! IP domains. FIG. 1 illustrates an example of web servers 150-151 that store content residing within an IP domain 160. Network device 130 can restrict user systems 120₁-120_{N} to only being able to access content in domain 160 to implement default parental control settings in guest mode.

Network device 130 by default restricts user systems 120 with known and unknown MAC addresses to the pre-selected Internet content in guest mode. A user is allowed less restrictive access to the Internet only after successfully logging into a user account that is assigned to a less restrictive parental control setting.

At step 215, network device 130 allows a user on user system 120 to enter a user identification (ID) or login and a password to log onto a user account. The user account can be, for example, a Yahoo! user account. The user account can be associated with a preset parental control setting. The parental control settings define a level of Internet access that is allowed for each user account. For example, the user account parental controls settings can allow full Internet access or block pornographic web sites.

At step 216, network device 130 passes the user ID and password to a server for authentication. If the user ID and password are authenticated, the server responds to network device 130 with a valid parental control setting and valid ID/password for the user account. At decisional step 217, network device 130 determines whether the server has responded with valid ID/password and a valid parental control setting.

If the server has responded with a valid parental control setting and valid user account ID/password, network device 130 receives and enforces the parental control setting assigned to the user account at step 218. The user is then restricted to accessing Internet content that is permitted by the parental control setting for the user account. The parental control setting assigned to the user account can be less restrictive than the guest mode, allowing an individual user greater Internet access than allowed in guest mode.

If the server has not responded with valid parental control settings and a valid ID and password, network device 130 sets the IP address for the requesting user system 120 to the default guest mode at step 219. Therefore, the user is given at least one attempt to login to a user account to bypass guest mode and to be allowed potentially greater Internet access.

If the user's attempt to login to a user account fails, the user is restricted to the web content predefined by the guest mode. Network device 130 can allow the user to conduct multiple attempts to login to a user account to bypass the guest mode. If desired; network device 130 can limit the number of times the user is allowed to attempt to login to a particular user account before the user account is locked.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

1. A method for restricting Internet access from a user system, the method comprising:
issuing an Internet Protocol (IP) address to the user system;
receiving a request from the user system at a network device to access the Internet;
restricting the user system to accessing only previously selected Internet content in a guest mode without logging into a user account;
allowing a user on the user system to login to a user account, wherein a parental control setting is assigned to the user account;
transmitting a login for the user account to a server for authentication;
receiving the parental control setting for the user account from the server indicating that the user account has been authenticated; and
restricting the user system to Internet content allowed by the parental control setting for the user account.

2. The method according to claim 1 wherein the previously selected Internet content in the guest mode is content within one pre-selected domain name.

3. The method according to claim 1 wherein the previously selected Internet content in the guest mode is a locally hosted login page stored on the network device.

4. The method according to claim 1 wherein the network device is a gateway router.

5. The method according to claim 4 wherein a plurality of user systems are connected to the Internet through the gateway router.

6. The method according to claim 1 further comprising:
allowing a second user on the user system to login to a second user account, wherein a second parental control setting is assigned to the second user account;
transmitting a second login for the second user account to the server for authentication;
receiving a signal from the server indicating that the second user account has not been authenticated; and
continuing to restrict the user system to the previously selected Internet content in the guest mode.

7. The method according to claim 6 wherein allowing the user on the user system to login to the user account further comprises allowing the user on the user system to attempt to login to the user account multiple times up to a preset limit of login attempts.

8. The method according to claim 1 wherein issuing the Internet Protocol (IP) address to the user system further comprises issuing an IP address to the user system even though the network device does not recognize the user system.

9. The method according to claim 1 wherein restricting the user system to Internet content allowed by the parental control setting for the user account further comprising allowing the user to have unrestricted access to the Internet in response to the parental control settings.

10. The method according to claim 1 wherein the user system is a wireless mobile device that communicates with the network device.

11. A computer program product that restricts access to the Internet from a user system, the computer program product being stored on a computer readable medium, the computer program product comprising:
code for issuing an Internet Protocol (IP) address to the user system;
code for receiving a request from the user system at a network device to access an Internet domain;
code for restricting the user system to accessing only previously selected Internet content in a guest mode using the network device without logging into a user account;
code for allowing a user on the user system to logon to a user account, wherein a parental control setting is assigned to the user account;
code for transmitting a login for the user account to a server for authentication;
code for receiving the parental control setting for the user account from the server indicating that the user account has been authenticated; and
code for restricting the user system to accessing only Internet content allowed by the parental control setting for the user account using the network device.

12. The computer program product according to claim 11 wherein the previously selected Internet content in the guest mode is content within one pre-selected domain name.

13. The computer program product according to claim 11 wherein the previously selected Internet content in the guest mode is a locally hosted login page stored on the network device.

14. The computer program product according to claim 11 wherein the network device is a gateway router.

15. The computer program product according to claim 14 wherein a plurality of user systems are connected to the Internet through the gateway router.

16. The computer program product according to claim 11 further comprising:
code for receiving a signal from the server indicating that the user account has not been authenticated; and
code for continuing to restrict the user system to the previously selected Internet content in the guest mode.

17. The computer program product according to claim 16 wherein the code for allowing the user on the user system to logon to the user account further comprises code for allowing the user on the user system to attempt to login to the user account multiple times up to a preset limit of login attempts.

18. The computer program product according to claim 11 wherein the code for issuing the Internet Protocol (IP) address to the user system further comprises code for issuing an IP address to the user system even though the network device does not recognize the user system.

19. The computer program product according to claim 11 wherein the code for restricting the user system to Internet content allowed by the parental control setting for the user account further comprising code for allowing the user to have unrestricted access to the Internet based on the parental control settings.

20. The computer program product according to claim 11 wherein the user system is a wireless mobile device that communicates with the network device.
